(19) United States
(12) Patent Application Publication
(10) Pub. No.: US 2021/0279812 A1
(43) Pub. Date: Sep. 9, 2021

(54) IDENTIFYING HEALTHCARE INSURANCE PAYMENT ARBITRAGE OPPORTUNITIES USING A MACHINE LEARNING NETWORK

(71) Applicant: DeRoyal Industries, Inc., Powell, TN (US)

(72) Inventor: Brian C. DeBusk, Knoxville, TN (US)

(73) Assignee: DeRoyal Industries, Inc., Powell, TN (US)

(21) Appl. No.: 17/195,815

(22) Filed: Mar. 9, 2021

Related U.S. Application Data
(60) Provisional application No. 62/986,870, filed on Mar. 9, 2020.

(51) Int. Cl. G06Q 40/08; G06Q 10/10; G06Q 50/00; G06N 3/04

(52) U.S. Cl. CPC G06Q 40/08; G06N 3/049; G06Q 50/01; G06Q 10/10

(57) ABSTRACT

A computer-implemented method identifies insurance risk adjustment opportunities for healthcare expenses of healthcare insurance program enrollees. The method includes providing inputs for each enrollee to a machine learning network. The inputs may include Center for Medicare and Medicaid Services Hierarchical Condition Category (CMS-HCC) values, an enrollee claims history, and enrollee historical spending amounts. Based on the inputs, the machine learning network is trained to predict future healthcare spending for the enrollees. After training, the machine learning network identifies enrollees having predicted future healthcare spending that differs from an amount determined based on a base risk score. Upon identifying an enrollee whose predicted future spending is greater than the amount determined based on the base risk score, one or more actions are taken: (1) performing outreach to or intervention for the identified enrollee; (2) disenrolling or discouraging the identified enrollee from participating in the insurance program; and (3) capturing additional CMS-HCC values that may increase the payment amounts for the identified enrollee. Upon identifying an enrollee whose predicted future healthcare spending is less than the amount determined based on the base risk score, action is taken to retain the identified enrollee.

### RELATED APPLICATIONS

This application claims priority to U.S. provisional patent application Ser. No. 62/986,870, filed Mar. 9, 2020, titled “Neural Network Incorporating Traditional Risk-Adjustment Metrics Combined with Loss History Data and Social Media Data to Identify Insurance Payment Arbitrage Opportunities,” the entirety of which is incorporated herein by reference.

### FIELD

This invention relates to the use of a machine learning network to identify insurance risk arbitrage opportunities for healthcare expenses. The network observes traditional risk score factors and blends them with a combination of claims history, historical spending, and information available through social media networks.

### BACKGROUND

The traditional Medicare Fee-for-Service (FFS) benefit began in 1965 for U.S. citizens who are 65 years or older, or who qualify based on certain types of disability. The U.S. government serves as the insurer for these beneficiaries, and individual claims are paid to physicians and other providers as deemed necessary and beneficial. These payments are made on a claim-by-claim basis with the U.S. government assuming full cost risk for the beneficiary, minus the appropriate amount of beneficiary cost-sharing. Individuals are exposed to limited cost sharing in the form of deductibles and copayments, but these amounts can be further mitigated by supplemental insurance products. Across 60 million Medicare beneficiaries, approximately two-thirds receive their healthcare benefits through the FFS system.

About one-third of Medicare beneficiaries are insured through private Health Maintenance Organization (HMO) or Preferred Provider Organization (PPO) plans. For these private plans, funds that are normally allocated to FFS beneficiaries' claims are instead paid to a third party in a lump sum, with the third party assuming full insurance risk. The third party provider is allowed to manage the delivery of care to the enrollee through a variety of methods. Examples of such management include the narrowing of networks (excluding certain providers from the plan), step therapy (requiring patients try certain treatments before escalating care), and prior authorization (requiring physicians and other providers to seek approvals from the payer prior to rendering service). These private plans also structure cost-sharing payments to be collected from enrollees, but these amounts are typically less than their corresponding cost under FFS. When payments to these plans exceed their cost, the private plan produces a profit. This creates incentives to deliver care through a combination of less service use, lower-cost substitute services, and/or lower-priced services.

The lump sum payment that the U.S. government transfers to the private plan is based on the anticipated amount of FFS spending for a beneficiary of nominal health, which private insurance companies then “bid” against. These bids are against the benchmark price—not against bids from other plan competitors. Plans with bids below the benchmark spending target receive rebates to be applied as additional benefits to the beneficiary. Plans with bids above the benchmark target must collect additional premiums from the beneficiary. In 2019, the average payment to plans for a beneficiary of average health were approximately $900/month.

The initial payment amount is determined for an enrollee of average health, and the payment amount is adjusted on a enrollee-by-enrollee basis to account for clinical risk factors. These factors are incorporated into a risk adjustment model referred to as the Center for Medicare and Medicaid Services Hierarchical Condition Categories (CMS-HCCs). Examples of clinical conditions within this model include diabetes, mental illness, cancer, acute myocardial infarction, stroke, and congestive heart failure. Risk adjustments made through the CMS-HCC model can have a significant impact on payments made to plans. Whereas the nominal payment is around $900 per month, these adjustments result in payments that can easily vary over a wide range (i.e. $650 to $4,500 per month) based on the specific characteristics of each enrollee.

Individual CMS-HCC coefficients are established by a linear regression across virtually the entire base of FFS beneficiaries. Because differing populations of beneficiaries have differing cost sensitivities to various clinical conditions, multiple CMS-HCC models (sets of coefficients) are deployed. For example, there is a set of CMS-HHC coefficients for beneficiaries who are new to Medicare, beneficiaries who are institutionalized, beneficiaries who have aged into Medicare and are not institutionalized with full dual-eligible benefits, and beneficiaries who receive Medicare due to disability with partial dual eligibility and are not institutionalized.

It has been reported that the CMS-HCC models do not accurately capture the complete cost for the most clinically complex beneficiaries. When a patient has numerous complex conditions, the models tend to understate the necessary cost adjustments. Similarly, the anticipated costs of patients with few or no clinical conditions are often overestimated. Embodiments described herein correct for this underestimating and overestimating through the use of non-linear modeling.

Although cost adjustments are made on a enrollee-by-enrollee basis, the aggregate risk is intended to be distributed across a broad population of beneficiaries. For any specific enrollee, the risk-adjusted amount is intended to represent a nominal amount of spending—not a precise spending amount for that individual. However, if it is possible to identify a set of individuals whose actual financial risk is above or below the CMS-HCC based benchmark, and if the sample group is large enough, aggregate spending for the group should be reliably higher or lower.

### SUMMARY

The above and other needs are met by a computer-implemented method for identifying insurance risk adjustment opportunities for healthcare expenses of healthcare insurance program enrollees. In a preferred embodiment, the method includes the following steps:
(a) for each enrollee, determining a base risk score based on a base risk-adjusted payment model;
(b) providing one or more inputs for each enrollee to a machine learning network, the one or more inputs including one or more of Center for Medicare and Medicaid Services Hierarchical Condition Category (CMS-HCC) values, an enrollee claims history, and enrollee historical spending amounts;
(c) training the machine learning network based on the one or more inputs to predict future healthcare spending for the enrollees;
(d) the machine learning network identifying enrollees whose predicted future healthcare spending differs from an amount determined based on the base risk score;
(e) upon identifying an enrollee whose predicted future healthcare spending is greater than the amount determined based on the base risk score, taking one or more of the following actions:
   performing outreach to or intervention for the identified enrollee;
   disenrolling or discouraging the identified enrollee from participating in the healthcare insurance program; and
   capturing additional CMS-HCC values that may increase the payment amounts for the identified enrollee; and
(f) upon identifying an enrollee whose predicted future healthcare spending is less than the amount determined based on the base risk score, taking action to retain the identified enrollee.

In some embodiments, the step of providing one or more inputs to the machine learning network for each enrollee includes providing information related to social media activity of each enrollee.

In some embodiments, the information related to the social media activity of each enrollee is obtained using automated software programs that collect information from social media accounts associated with the enrollees.

In some embodiments, the information related to the social media activity of each enrollee includes one or more of metadata, text data, image data, and video data from social media accounts associated with the enrollees.

In some embodiments, the information related to the social media activity of each enrollee is provided to the machine learning network in lieu of the enrollee claims history.

In some embodiments, the information related to the social media activity of each enrollee is provided to the machine learning network in addition to the enrollee claims history.

In some embodiments, step (f) includes taking action to retain the identified enrollee for additional plan years through one or more of telephone marketing, direct mailing marketing, and online marketing.

### BRIEF DESCRIPTION OF THE DRAWINGS

Other embodiments of the invention will become apparent by reference to the detailed description in conjunction with the figures, wherein elements are not to scale so as to more clearly show the details, wherein like reference numbers indicate like elements throughout the several views, and wherein:

FIG. 1 depicts a system for identifying insurance risk arbitrage opportunities for healthcare expenses according to an embodiment of the invention; and

FIG. 2 depicts a method for identifying insurance risk arbitrage opportunities for healthcare expenses according to an embodiment of the invention.

### DETAILED DESCRIPTION

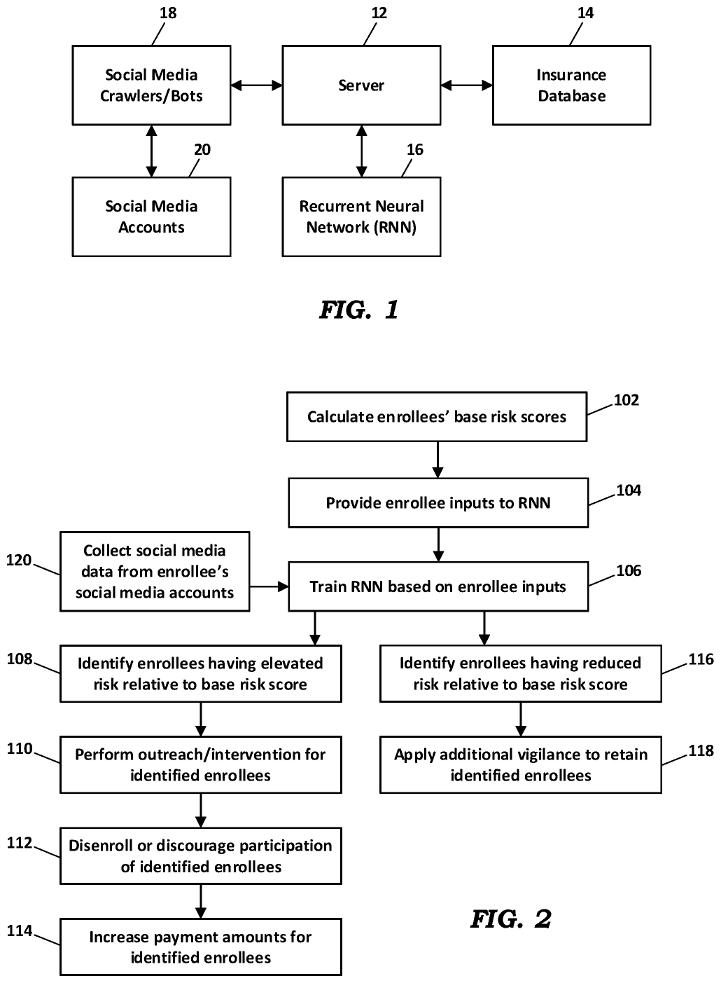

As depicted in FIGS. 1 and 2, a preferred embodiment described herein is directed to a computer system that includes a server computer 12 programmed to calculate a base risk score using a base risk-adjusted payment model for each insurance beneficiary (step 102 in FIG. 2). The server 12 provides the Center for Medicare and Medicaid Services Hierarchical Condition Category (CMS-HCC) values for each beneficiary, a brief claims history, and historical spending amounts to a machine learning network 16, such as a recurrent neural network (RNN) (step 104). The CMS-HCC values, claims history, and historical spending data are maintained in an insurance enrollee database 14. Once the RNN 16 has been trained to anticipate future healthcare spending for each enrollee (step 106), the RNN 16 identifies enrollees whose future spending differs significantly from the base risk score provided through the base risk-adjusted payment model (steps 108 and 116).

Once a beneficiary has been identified as having elevated risk relative to their base risk score (step 108), the server computer 12 may generate recommendations for the insurance company to take one or more actions, including:
performing outreach to or intervention for the enrollee (step 110);
disenrolling or otherwise discouraging the enrollee from further participation in the insurance plan (step 112); and
capturing additional CMS-HCC values that may increase the payment amounts for the enrollee (step 114).
   Because the variance in anticipated spending may result from a enrollee who is not completely risk-scored (e.g. new to Medicare or an enrollee who seldom sees their physician), the system may be useful in identifying under-coded individuals as well.

If a specific enrollee is identified as having reduced risk relative to their base risk score (step 116), the enrollee could be a source of greater profit margin to the private insurance plan. In this situation, the server computer 12 may generate recommendations for the insurance company to choose to apply additional vigilance to retain the specific enrollee (step 118). This could include telephone marketing, direct mailing materials, or any other activities associated with securing the enrollee for additional plan years.

In some embodiments, the RNN 16 also incorporates information related to a enrollee's social media presence into the risk calculation score, either in lieu of or in conjunction with the enrollee's claims history. In this embodiment, automated software programs 18, also commonly referred to as “bots” or “crawlers,” collect metadata, text, image, and video data from social media accounts 20 (step 120). Examples of such automated software programs 18 include Twitterbots, Facebook Crawlers, and Instagram Bots. The collected social media data are provided to the RNN 16 for training purposes to enhance the RNN's ability to estimate future financial risk for individual enrollees.

The metadata, text, image, and video data collected from an enrollee's social media accounts 20 provide additional insight for risk adjustment. For example, social media posts referring to depression, drug or alcohol use, insomnia, or anxiety are indicators that the enrollee may have a poor mental health status. Similarly, positive posts referring to vacations, pets, exercise, or children/grandchildren may indicate the enrollee has above-average mental health status. In some embodiments, a social media front-end processor uses a Convolutional Neural Network (CNN) to process the social media images, and a separate machine learning network to process the social media text. In these embodiments, the social media front-end processor feeds the processed social media data to the RNN 16 for estimating future healthcare spending.

In some embodiments, the RNN 16 is not given a bias in how to interpret the social media information. For example, a photo of a beneficiary running a marathon is not scored as beneficial or detrimental to future cost. In these embodiments, the network simply observes the enrollee's CMS-HCC values, additional demographics data, claims history, and social media data, and then anticipates future costs.

Training the RNN 16 is a continuous process. As an enrollee's CMS-HCC coefficients, claims history, and social media presence change over time, new spending estimates are calculated. These new estimates presumably become more accurate over time as more data are collected. These estimates would be updated virtually continuously, with the internal weights of the machine learning network being modified to accommodate the observed changes.

Data from the social media accounts 20 may also be used to identify future customers for the insurance company. Ultimately this tool may be used not only to groom existing beneficiary pools, but also to identify future customers from outside the insurance company's enrollee base.

The foregoing description of preferred embodiments for this invention have been presented for purposes of illustration and description. They are not intended to be exhaustive or to limit the invention to the precise form disclosed. Obvious modifications or variations are possible in light of the above teachings. The embodiments are chosen and described in an effort to provide the best illustrations of the principles of the invention and its practical application, and to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

What is claimed is:

1. A computer-implemented method for identifying insurance risk adjustment opportunities for healthcare expenses of healthcare insurance program enrollees, comprising:
(a) for each enrollee, determining a base risk score based on a base risk-adjusted payment model;
(b) providing one or more inputs for each enrollee to a machine learning network, the one or more inputs including one or more of Center for Medicare and Medicaid Services Hierarchical Condition Category (CMS-HCC) values, an enrollee claims history, and enrollee historical spending amounts;
(c) training the machine learning network based on the one or more inputs to predict future healthcare spending for the enrollees;
(d) the machine learning network identifying enrollees whose predicted future healthcare spending differs from an amount determined based on the base risk score;
(e) upon identifying an enrollee whose predicted future healthcare spending is greater than the amount determined based on the base risk score, taking one or more of the following actions:
performing outreach to or intervention for the identified enrollee;
disenrolling or discouraging the identified enrollee from participating in the healthcare insurance program; and
capturing additional CMS-HCC values that may increase the payment amounts for the identified enrollee; and
(f) upon identifying an enrollee whose predicted future healthcare spending is less than the amount determined based on the base risk score, taking action to retain the identified enrollee.

2. The method of claim 1 wherein the step of providing one or more inputs to the machine learning network for each enrollee includes providing information related to social media activity of each enrollee.

3. The method of claim 2 wherein the information related to the social media activity of each enrollee is obtained using automated software programs that collect information from social media accounts associated with the enrollees.

4. The method of claim 2 wherein the information related to the social media activity of each enrollee includes one or more of metadata, text data, image data, and video data from social media accounts associated with the enrollees.

5. The method of claim 2 wherein the information related to the social media activity of each enrollee is provided to the machine learning network in lieu of the enrollee claims history.

6. The method of claim 2 wherein the information related to the social media activity of each enrollee is provided to the machine learning network in addition to the enrollee claims history.

7. The method of claim 1 wherein step (f) includes taking action to retain the identified enrollee for additional plan years through one or more of telephone marketing, direct mailing marketing, and online marketing.
